(19) United States
(12) Patent Application Publication
(10) Pub. No.: US 2026/0099588 A1
(43) Pub. Date: Apr. 9, 2026

(54) SYSTEM AND A METHOD TO DETECT BROWSER SESSION TOKEN THEFT USING DECOY TOKENS AND DECOY TOKEN SITE NETWORK

(71) Applicant: NECTARNETICS LLC, Cerritos, CA (US)

(72) Inventor: Skylar Glass, Whittier, CA (US)

(21) Appl. No.: 18/909,355

(22) Filed: Oct. 8, 2024

(51) Int. Cl. G06F 21/55

(52) U.S. Cl. CPC G06F 21/55; G06F 2221/034

(57) ABSTRACT

The present invention provides a cybersecurity system and method for monitoring and detecting session token theft from a device. The system comprising a primary web-based application that detects the theft and misuse of browser session tokens by deploying decoy tokens and a network of decoy sites. The system generates decoy session tokens that closely mimic legitimate session tokens by encrypting unique client identifiers and base64 encoding the resulting data. These decoy tokens are injected into the browser via a browser extension and monitored by the primary application for any unauthorized use. When an attacker attempts to use a stolen decoy session token, the system triggers an alert, enabling rapid response and mitigation.

### FIELD OF THE INVENTION

The present invention relates generally to computer security, and, more particularly, to a system and a method for detecting theft of browser session tokens.

### BACKGROUND

In the modern digital era, web browsers are integral to accessing and interacting with online services, making them a primary target for cybercriminals. One prevalent threat is the theft of browser session tokens, which are used to maintain authenticated sessions without requiring users to repeatedly log in. Browser session tokens are the general mechanism used to identify and authenticate a user in a web application. They store a unique identifier for a user's session and allow the user to log in to the application using a browser. The session token stores a unique identifier for a user's session and allows them to log in to the application using the browser. Subsequent requests made by the user to the server have the session token attached. The server, in turn, uses the token to recognize the user, forgoing the need for repetitive credential verification. Once the session token is activated, it becomes the user's passkey for that session. The session tokens are generally stored in the browser on the client side, and if stolen, can be used to retrieve data and perform actions on the web application. These tokens, if stolen, can grant unauthorized access to sensitive user accounts, leading to significant data breaches and financial losses.

Hackers try to steal session token information to gain unauthorized access to the web server. The session token can be compromised in different ways, such as predictable session token, session sniffing, client-side attacks. Once in possession of the token, the hacker effectively bypasses multi-factor authentication and starts an illegitimate session without requiring further multi-factor authentication verification. The hacker can access proprietary information and can carry out actions of modifying or deleting data or altering system configuration.

Preventing the theft of session token is a challenging task, in particular, because of breadth of attack surface. Traditional methods for detecting such theft often rely on endpoint detection and response (EDR) systems, antivirus software, or third-party cybersecurity intelligence that monitors for stolen credentials on the dark web. Systems typically employ agents, binaries, or executables running on the user's machine to monitor for malicious activity. While these preventative solutions can be effective to some extent, they can be bypassed by sophisticated malware or info stealer malware, potentially leading to session token theft. Moreover, these conventional methods, however, can be slow and reactive, often detecting the compromise only after the stolen tokens have been misused or offered for sale.

To overcome the disadvantages associated with the state of the art, the present invention provides a system and method that detects session token theft attempts by leveraging the web browser itself rather than relying on traditional endpoint agents or binaries. The invention provides a proactive mechanism for identifying and responding to cyberattacks that involve stolen session tokens.

### SUMMARY

The present invention provides a cybersecurity solution designed to detect theft and misuse of browser session tokens through the deployment of decoy session tokens and a network of decoy sites. The system detects unauthorized use of these decoy session tokens, which are injected into the browser via a browser extension, by monitoring a network of decoy sites rather than using endpoint agents or binaries. The system generates decoy session tokens that closely mimic legitimate session tokens. When an attacker attempts to use a stolen session token, including a decoy token, the system detects the unauthorized attempt. When unauthorized use of a decoy session token is detected on the decoy site network, the system triggers an alert. This alert includes a mapping of the unauthorized use back to the original user's sessions, helping to identify the scope of the compromise. This real-time detection capability does not extend to the initial theft of legitimate session tokens, which are identified through analysis and correlation with telemetry data.

According to a first aspect of the present invention, there is provided a system for detecting browser session token theft. The system comprising: a web application configured to generate a plurality of decoy session tokens; a browser extension on a client device that stores the plurality of decoy session tokens and a plurality of legitimate session tokens, with the client device transmitting telemetry data to the web application; a network of decoy sites designed to monitor the usage of the plurality of decoy session tokens and detect unauthorized use of a decoy session token, with the network of decoy sites transmitting a signal to the web application upon detecting unauthorized use; an analytics module in the web application to map the decoy session token with the telemetry data from the client device to identify compromised legitimate session tokens; wherein the web application provides notifications to the client device and sends a list of compromised legitimate session tokens.

In an embodiment of the present invention, the telemetry data of the client device comprising web domain names for cookies or session tokens stored in the browser extension, user agent, and public IP address.

In an embodiment of the present invention, the decoy session tokens are generated to closely mimic the characteristics of legitimate session tokens to enhance their effectiveness.

In an embodiment of the present invention, the system further comprising: a session correlation database that maintains mapping between decoy session tokens and the original session tokens to accurately identify compromised tokens.

In an embodiment of the present invention, the network of decoy sites is configurable to resemble various types of services, providing flexibility to deploy decoy sites that appear to host different legitimate services.

In an embodiment of the present invention, the alert mechanism includes: real-time notifications sent to users and administrators detailing the unauthorized attempt, including IP address, time of attempt, and specific decoy token used.

According to a second aspect of the present invention, a method for detecting browser session token theft is provided. The method comprising: generating decoy session tokens on a server; storing the decoy session tokens in the user's browser through a browser extension; collecting telemetry data from the user's browser to identify potential theft of session tokens; monitoring a network of decoy sites for unauthorized attempts to use the decoy session tokens; triggering alerts hen unauthorized use of a decoy session token is detected, the system triggers an alert. This alert includes a mapping of the unauthorized use back to the original user's sessions, helping to identify the scope of the compromise.

In an embodiment of the present invention, the method further comprising: storing metadata about each decoy session token, including creation time, associated real session token, and any detected unauthorized attempts, in a secure database.

In an embodiment of the present invention, the injection of decoy session tokens is adaptive, adjusting the distribution and characteristics of decoy tokens based on observed attack patterns and threat intelligence.

According to a third aspect of the present invention, a system for detecting browser session token theft is provided. The system comprising: a server module that generates and manages decoy session tokens; a browser extension that stores the decoy session tokens within the browser and collects telemetry data from the user's browser; a network of decoy websites that mimic legitimate services to detect unauthorized use of session tokens; a detection module that identifies and logs unauthorized attempts to use decoy session tokens; a notification system that issues alerts upon detecting unauthorized use of decoy tokens, enabling rapid response.

In an embodiment of the present invention, the system further comprising a browser extension that facilitates the storage and management of decoy session tokens within the user's browser environment.

In an embodiment of the present invention, the detection module utilizes advanced algorithms to analyze patterns of unauthorized attempts on decoy sites, improving the accuracy and speed of threat detection.

In an embodiment of the present invention, the notification system integrates with existing security information systems to provide comprehensive threat analysis and response capabilities.

In an embodiment of the present invention, the system further comprising: a method for integrating the decoy token detection capabilities with third-party security tools and platforms, facilitating alerts or notifications and enhancing overall security posture.

In the context of the specification, the term “processor” refers to one or more of a microprocessor, a microcontroller, a general-purpose processor, a Field Programmable Gate Array (FPGA), or an Application Specific Integrated Circuit (ASIC), and the like.

In the context of the specification, the phrase “memory unit” refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrase “storage device” refers to non-volatile storage memory such as EPROM, EEPROM, flash memory, or the like.

In the context of the specification, the phrase “communication interface” refers to a device or a module enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

In the context of the specification, the phrase “communication network” refers to a group of several connected devices including computing devices (such as desktops, mobile handheld devices, tablet PCs, notebooks, etc.), local and remotely located servers (such as web servers, application servers, database servers, Application Program Interface (API) servers, load balancers, compute nodes, and the like), routers, antennas, modems, multiplexers, demultiplexers, and the like. In that regard, the aforementioned connected devices may be able to exchange data signals through wired and/or wireless means as per several combinations of several different communication protocols such as 802.11 (Wi-Fi), 802.3 (Ethernet), Bluetooth, NFC, ZigBee and 3GPP protocols such as HSPA, HSDPA, LTE, GSM, CDMA, WLL and the like.

Reference throughout this specification to “one embodiment,” “an embodiment,” or similar language means that a particular feature, structure, or characteristic described in connection with the embodiment is included in at least one embodiment of the present disclosure. Thus, appearances of the phrases “In an embodiment,” “in an embodiment,” “in another embodiment,” “in various non-limiting embodiments,” and similar language throughout this specification may, but do not necessarily, all refer to the same embodiment.

In the context of the specification, the term, “real-time”, refers to without intentional delay, given the processing limitations of hardware/software/firmware involved and the time required to accurately measure/receive/process/transmit data as practically possible.

In the context of the specification, the term “modules,” is considered a computer-executable program stored on a computer-readable storage medium. The term “modules” is used in some embodiments of the present disclosure. The modules (e.g. in/at a node/computer/server) provide information to the second node/computer/device (e.g. to the user of the second node/computer/device), with the modules carrying one or more sequences of instructions, wherein execution of the one or more sequences of instructions by one or more processors embodied therein causes the one or more processors to perform a method for providing interactive information to the user using a computer/device (e.g. a laptop computer, a desktop computer, a mobile device, cellular phone, a wireless-enable-computer, and/or the like), typically with a display and input method (e.g. keypad, touchscreen, audio commands, speaker, audio translator, motion detection, and/or the like) as a communication/interaction device.

Modules can be implemented in software for execution by various types of processors. An identified module of executable code can, for instance, comprising one or more physical or logical blocks of computer instructions, which can, for instance, be organized as an object, procedure, or function. Nevertheless, the executables of an identified module need not be physically located together, but can comprise disparate instructions electronically stored in different locations which, when joined logically together, comprise the module and achieve the stated purpose for the module.

Further, storage medium can include, but is not limited to, one or more of the following: any type of physical media, including floppy disks, optical discs, DVDs, CD-ROMs, microdrives, magneto-optical disks, holographic storage devices, ROMs, RAMs, EPROMs, EEPROMs, DRAMs, PRAMS, VRAMs, flash memory devices, magnetic or optical cards, nano-systems (including molecular memory ICs); paper or paper-based media; and any type of media or device suitable for storing instructions and/or information. Various embodiments include a computer program product that can be transmitted in whole or in part and over one or more public and/or private networks wherein the transmission includes instructions and/or information which can be used by one or more processors to perform any of the features presented herein.

A module of executable code can be a single instruction, or many instructions, and may even be distributed over several different code segments, among different programs, and across several memory devices. Similarly, operational data may be identified and illustrated herein within modules, and may be embodied in any suitable form and organized within any suitable type of data structure. In various non-limiting embodiments, the operational data may be collected as a single data set, or may be distributed over different locations including over different storage devices, and may exist, at least partially, merely as electronic signals on a system or network.

### BRIEF DESCRIPTION OF DRAWINGS

The preferred embodiment of the invention will hereinafter be described in conjunction with the appended drawings provided to illustrate and not to limit the scope of the invention, wherein like designation denote like element and in which:

FIG. 1 illustrates an exemplary network environment in which embodiments of the invention may be deployed.

FIG. 2 illustrates a system architecture to detect the browser session token theft, in accordance with an embodiment of the present invention.

FIG. 3 illustrates a system to detect the browser session token theft in real-time, in accordance with an embodiment of the present invention.

FIG. 4 illustrates a process for detecting the browser session token theft, in accordance with an embodiment of the present invention.

### DETAILED DESCRIPTION

In the following detailed description of embodiments of the invention, numerous specific details are set forth in order to provide a thorough understanding of the embodiments of the invention. However, it will be obvious to a person skilled in art that the embodiments of the invention may be practiced with or without these specific details. In other instances, well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

Embodiments of the present invention describe a system for detecting a theft and misuse of browser session tokens through deployment of decoy tokens and a Decoy Token Site Network. The system generates decoy session tokens that mimic legitimate session tokens. These tokens are indistinguishable from real tokens to potential attackers, and are continuously (e.g., on hourly basis) monitored for any unauthorized use. When an attacker attempts to use a stolen session token, including the decoy token, the system detects the activity. The detection occurs when the decoy token is used, and trigger an alert which also includes a mapping of the unauthorized attempt back to the original user's session.

In an embodiment, the decoy session token generation process may involve at least one or more of the following steps:
a. Collecting unique identifiers related to a client.
b. Encrypting these identifiers.
c. Base64 encoding the encrypted data to produce a decoy session token that resembles a valid JWT or session token. Each decoy session token is unique to its corresponding decoy domain, ensuring that if there are multiple decoy sites, each site will have a distinct decoy session token injected into the browser.

In an embodiment, the system utilizes a decoy token site network that includes a network of decoy sites that mimic legitimate services, such as financial, health, cloud storage enterprise, remote support services, etc. These decoy sites are designed to entice attackers to use stolen session tokens, facilitating detection. The decoy token site network serves as honeypots, identifying unauthorized access attempts and reporting the unauthorized access for analysis.

In an embodiment, the system identifies the exact session tokens or cookies present in the user's browser at the time of theft. The system provides instant notifications of any illicit attempts to use the decoy tokens on the decoy site network, allowing for a rapid response to potential threats.

In an embodiment of present invention, the system utilizes session token information present in the user's web browser or application. The system does not require any additional software to be installed on the user's device. The system operates entirely within the browser environment, offering seamless protection without impacting the user experience.

In an embodiment of the present invention, the system maintains a correlation between the decoy tokens and the user's actual session tokens. The correlation enables precise identification of which tokens are compromised and facilitates swift remediation action.

In an embodiment of the present invention, the system can proactively detect unauthorized attempt to use stolen token by deploying decoy tokens and utilizing the decoy token site network, which significantly reduce the dwell time between compromise and detection. The system provides immediate alert to the users and administrators upon token misuse, allowing for faster mitigation and reducing the risk of data breaches. The browser-based approach eliminates the need for endpoint agents, reducing complexity and the potential for compatibility issues. The system provides clear visibility into the specific session tokens and cookies at risk, enabling targeted responses.

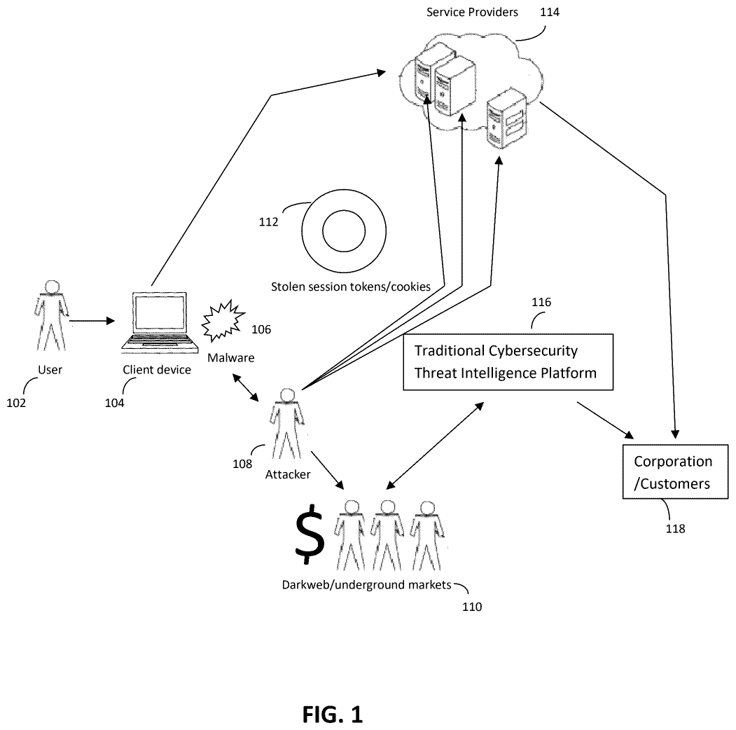

FIG. 1 illustrates an exemplary network environment in which embodiments of the invention may be deployed. A user 102 uses client devices 104 to communicate, via a network, with services 114. The client devices 104 may be any of a variety of computing devices including personal computers, laptop computers, desktop computers, workstations, personal digital assistants (PDAs), and/or the like. The network may be any of a variety of networks and may include wireless and wired connections, a variety of network components, and the like. For example, the network may include the Internet. Services 114 may be any of a variety of services, the clients desire to interact with via the network, such as online banking services, financial services, e-commerce merchants, and the like.

The hardware of a client device 104 comprising a computing core such as a microcontroller or microprocessor; input-output connections to a display, keypad or touch panel, ports, peripherals, sensors, and other interfaces; and data storage comprising non-volatile memory such as flash and scratch-pad memory such as DRAM and SRAM.

The client device 104 is able to receive commands from the user 102 and execute the tasks. In an embodiment, the client device 104 is connected to a network through transmission-control-protocol/Internet-protocol (TCP/IP) and is in communication with service providers via the network, such as online banking services, financial services, e-commerce, merchants and the like.

When the client device 104 communicates with the service provider 114 over the network, the client device 104 establishes a session with the service provider 114. The client device 104 and the web service establish ‘trust’ to open a channel by exchanging information using an encryption key, a signed digital certificate issued by a trust certificate authority. For example, when a user 102 opens an online session with a bank to access the bank account, the account holder's identity is verified during the login process using an authentication protocol. Once a session is established, the transaction performed while the session remains open do not require further verification and no additional authorization is needed.

When a session is opened, a session data structure is created to store information about a user session. The session data structure is identified by a token 112 which is stored in web browser cookies. The session token 112 is generated for every new session data structure. The session token 112 (or a session ID) is an encrypted unique string that identifies the specific session instances. Session tokens serve as identifiers that maintain the state and continuity of the client device 104 interaction with the web service 114. The session token 112 is generated and stored in web-browser cookies of the client device.

A threat actor or an attacker 108 uses several mechanisms to steal the session tokens stored in the client device 104, a proxy server, or in application or network logs. The attacker 108 steals the session tokens to access the user's data for as long as that stolen token 112 remains active. For instance, in an adversary-in-the-middle (AiTM) attack, the attacker intercepts communication between the user 102 and the service provider 114 to capture or hijack the session token. The attacker 108 may also employ a malicious code (e.g., an infostealer malware and spyware) 106 to capture session tokens by extracting session tokens from the client device 104. Once obtained, these tokens allow the attacker 108 to gain unauthorized access to user 102 data and perform malicious actions operating under the user's identity or account context that originally authenticated the session tokens. The attacker 108 may also use viruses or worms to subvert, cripple or destroy a system, to gather information using spyware, phishing, key loggers and Trojans by installing backdoors to take control of files and processes.

Once the attacker 108 gains access to the session token 112, the attacker takes over the already established legitimate session with the service provider 114 using the stolen session token 112. The session token 112 provides the attacker with unauthorized access to the user's accounts, exposure of sensitive information, which may result into losses and malicious activities, e.g., potential financial loss. The attacker 108 can use the ongoing session to commit various malicious acts, e.g., including stealing money from the user's bank account, purchasing items, exfiltrating sensitive data, conducting espionage, making malicious modifications, degrading services, and using the compromised account as a pivot point to compromise additional services or systems. The attacker 108 might also encrypt important data and demand a ransom for its return, or engage in other activities that result in financial loss, data breaches, and further security incidents.

After obtaining the session token 112, the attacker 108 may sell the information or access on the dark web 110, underground markets, through access brokers, or in data dumps 110, sometimes without ever using the session token 112 themselves. Corporations 118 often hire third-party intelligence companies 116 to monitor these cyber threats. These third-party cyber threat intelligence companies 116 continuously monitor these platforms, and when a threat actor or attacker 108 decides to place the stolen information or access up for sale, the intelligence companies 116 detect or procure it. The dwell time, which is the period between the theft and the detection or sale of the information, depends on several factors, including how quickly the attacker decides to place the information for sale, the vigilance of cyber threat intelligence efforts, and the detection capabilities of the service provider 114 and the client 104. In addition, the service provider 114 may identify the breach and take action, such as notifying the user 102 and initiating incident response procedures. This identification typically occurs after some time has passed or when a major impact has been detected. Prompt notification and response by the service provider 114 are essential in minimizing the damage and securing user accounts.

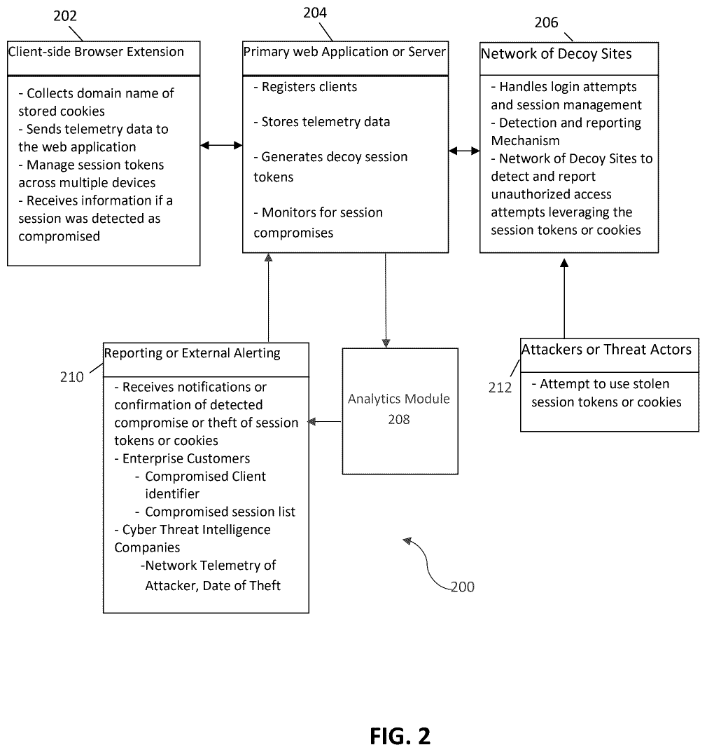

FIG. 2 illustrates a system architecture to detect a browser session token theft, in accordance with an embodiment of the present invention. Referring to FIG. 2, a system 200 for detecting and monitoring browser session token theft is illustrated. The system 200 comprising: a server component 204 configured to generate decoy session tokens; a client-end component 202 in form of a browser extension that stores decoy session tokens and collects client telemetry data; a monitoring network of decoy sites 206 designed to detect unauthorized use of session tokens; an alert mechanism 208 that provides notifications upon detection of unauthorized use of decoy session tokens, correlating the attempt with the user's session, and facilitating an automated response.

### Primary Web Application or Server 204

The term “server” means a server computer or a group of computers that act to provide a service for a certain function or access to a network source. The server may be a physical server, hosted server in a virtual environment, or software code running on a platform. The server is coupled, directly or indirectly, to one or more client device 104 through a network. The network can be the Internet, a Wide Area Network (WAN), a Local Area Network (LAN) or a combination thereof.

In an embodiment, the server component 204 is a web-based primary application 204 that communicates with client devices via a browser extension that leverages API endpoints. The primary application 204 is a proprietary platform hosted on a server. It provides third-party services to multiple client devices registered with the primary application 204, enabling the monitoring of sessions and detection of theft of session tokens or session cookies from these client devices by detecting attempts to use these stolen session tokens.

A client device interested in the monitoring and detection service for session token theft can register with the primary application 204, typically on a subscription basis. During the registration process, the primary application 204 generates a unique identifier for the client device. The users may optionally link their accounts to another service for enhanced functionality.

In an embodiment, the primary application 204 monitors session token theft by connecting to a network of decoy sites 206 designed to deceive attackers. These decoy sites mimic legitimate services and serve as honeypots. The primary application 204 generates decoy session tokens, also referred to as honey tokens, and transmits them to the client device. The decoy session tokens are stored in the web browser using a browser extension 202, making it difficult for attackers to distinguish them from legitimate session tokens. In an embodiment, the present system 200 specifically monitors the decoy site network for real-time detection of unauthorized attempts to use decoy session tokens. When a decoy session token is re-used on the decoy site network, the primary application 204 triggers an alert and provides detailed information about the unauthorized attempt. It is to be noted, that this real-time detection capability does not extend to the initial theft of legitimate session tokens, which are instead identified through analysis and correlation with telemetry data.

In an embodiment, the primary application 204 transmits a beacon at regular intervals to monitor the client device. The decoy session tokens are periodically updated, allowing any unauthorized access attempts to be accurately detected and pinpointed to a specific time frame. For example, the periodic update may be an hourly update.

In an embodiment, the primary application 204 collects telemetry data from the client device by sending a beacon at regular intervals. This telemetry data includes information such as active session tokens, domains, public IP addresses, and user agents. The collected telemetry data from multiple client devices is stored in a database within the primary application 204.

In an embodiment, the primary application 204 comprising an analytics module 208 and a reporting module 210. The analytics module 208 analyzes the captured telemetry data with the data from the network of decoy sites 206. This data received from the network of decoy sites 206 includes a list of decoy session tokens for which unauthorized access attempts were made. The analytics module 208 correlates this list that is received from the network of decoy sites 206 that includes the decoy session tokens which are transmitted from the attacker to the decoy site 206 (after it was stolen)) with the telemetry data to determine the client device which is being subjected to theft and the timing of the transmission. It then identifies the active legitimate session tokens at that time to map the compromised decoy session tokens to the legitimate session tokens, facilitating swift remediation action.

Thereafter, the reporting module 210 generates a report of the session compromise. The primary application 204 sends an alert/notification to the client device along with the report about the compromise of a session at the client device.

When the attacker steals session tokens from the client device browser, both legitimate and decoy session tokens are transmitted to the attacker's device. If the attacker uses any of the decoy session tokens to open a session with a decoy service provider in the decoy site network 205, it triggers an alert to the primary application 204. The primary application 204 continuously monitors the decoy site network 206, and upon detecting a new session initiated by the attacker, it transmits an alert to appropriate personnel, including and not limited to the client device, a third-party cybersecurity intelligence agency, a corporate/consumer, or the service provider. The alert mechanism may include sending notifications via email, SMS, browser notifications, or other methods.

### Client Side Browser Extension 202

The term “client” generally means software that communicates with a server, and “client device” refers to any computer, embedded device, mobile device or other system that can be used to perform the functionality describes as being performed by the client device.

The client device 202 runs a web-browser to access the web pages on the Internet. The web-pages accessed by the client device are of any service providers that provides services such as including and not limited to financial, e-commerce, utility services, or other authenticated services using session tokens for the end-users. A “service” is an online server or set of servers, and can refer to web-site or a web-application. A client device can access the web-page through the Internet. The access to the web-page is based on authorization or authentication platform that executes an authentication/login process or functional component.

During the communication, a user may request a target server to access a service provided by the service provider using the client device 202. The services are generally protected by an authentication protocol so that only authorized users may gain access. The authentication protocol generally involves use of appropriate credentials, such as a valid username, password, biometrics, etc. To gain access to the service provider web-page, the user must provide the proper credentials (login credential, cryptographic signature, a hash of the application or site code, universally unique ID, a token) in response to the challenge from the server. Credentials generally comprising any information that is presented to an authentication or authorization system for the purpose of authentication or authorization.

Once the user is authorized or authenticated by the server, the server establishes a session with the client device 202. The session information is stored in form of cookies or session token in the browser extension of the client device, and the corresponding information is also stored on the server so as to eliminate the need of re-authorization. A cookie set from any past contact with the server can be later provided by the client to associate the client with whatever the server knows about the previous client that got connected with the corresponding identifier. The stored session token is a random identifier that the server looks up in a dataset of known identifiers associated with accounts, and which may be digitally signed so that the server can verify that the token was created by a trusted entity, by which a client was previously authenticated with the server. The server stores the session token or other information, that the client stores and provides to the server in subsequent interactions proving that the client is associated with the previously authorized client.

The session tokens of the client device 202 are enticing to attackers as they appear to open a privileged session with the service provider, which can be used by them to steal the user's personal information, financial information etc. The attacker utilizes various malware, spyware and viruses to attack the client device in order to steal the active session tokens in the client device or perform Adversary-in-the-Middle (AiTM) attacks to hijack session tokens.

In an embodiment, the client device 202 registers/enrolls with the primary application 204 for it to monitor and detect the theft of the session tokens or cookies. The user authenticates to a service provider web application using the browser on the client device. The client device on registration accepts the end user license agreement.

In an embodiment, on registration with the primary application 204, the client device 202 transmits telemetry data to the primary application 204. The telemetry data includes and is not limited to domain names for active session tokens, public IP addresses, and user agents and the like. The telemetry data is used later by the primary application 204 to map to a user session to identify the exact list of compromised session tokens on the client device.

In an embodiment, the client device 202 manages session tokens stored in the browser. The user can be in multiple sessions with various service providers simultaneously. During normal browsing, the browser on the client device 202 stores session information, including session tokens and cookies, for various service providers. The browser extension specifically injects decoy session tokens which are generated and transmitted by the primary application 204, in addition to the legitimate session tokens already stored.

When an attacker steals the session tokens and decoy session tokens stored in the browser and opens a session with the decoy site network 206 using the decoy session token, the primary application 204 triggers an alert to the server which then notifies the client device that a session token of the client device 202 has been used for opening a session. The user of the client device receives the session compromise information and takes appropriate remedial steps.

### Network of Decoy Sites 206

The network of decoy sites 206 resembles the web pages of legitimate service providers and is deployed to deceive attackers. These decoy sites serve as “honeypots” by appearing real and enticing attackers to reuse stolen session tokens (decoy session tokens or honey tokens). The decoy site network 206 handles login or authentication attempts to identify when a stolen session token is reused.

When a login attempt is made by the attacker using the decoy session token, the decoy site network 206 detects the unauthorized use and provides a real-time alert to the primary application 204. The decoy site network reports the unauthorized access attempt, indicating the use of stolen decoy session tokens or cookies. The primary application 204 then decodes or decrypts the decoy session token to extract the identifier, mapping it to the corresponding client device. The primary application 204 analyzes the telemetry data of multiple client devices to identify the compromised client device and the compromised session tokens. The primary application 204 transmits an alert to the user of the client device, notifying them of the possible theft of session tokens stored in the browser.

### Attackers or Threat Actors 212

The attacker or threat actor 212 is an individual or group who attempts to steal session tokens or cookies from the client device's browser in order to hijack the user's session and steal information from the active session.

### Reporting or External Alerting 210

The primary application 204 includes a reporting or external alerting module 210, which receives notifications or confirmations of detected compromises or thefts of session tokens or cookies. The module specifically provides real-time alerts when unauthorized use of decoy session tokens is detected on the decoy site network. Customers of the primary application 204, including registered client devices, enterprises, and cyber threat intelligence companies, are regularly notified about compromised client identifiers and session tokens. For cyber threat intelligence companies, the system 200 provides network telemetry of attackers and dates of theft.

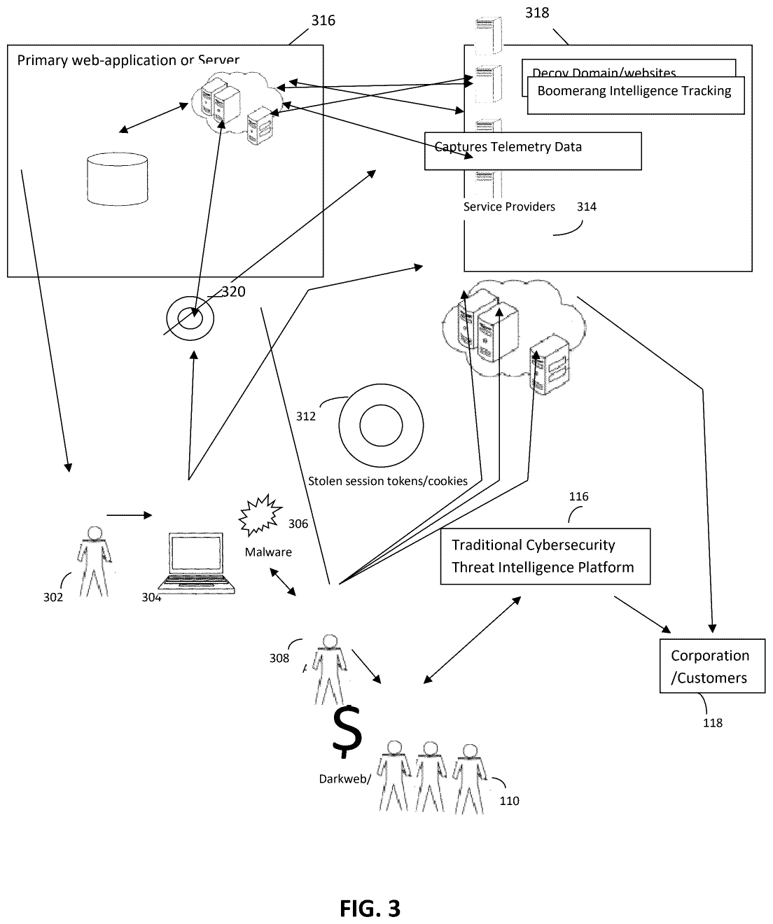

FIG. 3 illustrates a system to detect the browser session token theft in real-time, in accordance with an embodiment of the present invention. A user 302 registers a client device 304 with a primary application or server 316 that monitors the browser session token theft in real time and accepts end user license agreement. The client device 304 sends telemetry data to the primary application 316. The telemetry data includes and is not limited to web domain names for cookies or session tokens stored in the browser of the client device, user agent, public IP-address, etc. The telemetry data of the client device 304 is used by the primary application 316 to map a user session with the list of active session tokens or cookies at that point of time when a session was compromised. The client device 304 is able to receive and store session tokens from legitimate domains and decoy domains in the browser.

The user uses client devices 304 to communicate via a network with one or more service providers 314. When the client device 304 communicates with the service provider 314 over the network, the client device 304 establishes a session with the service provider 314. When a session is opened, a session data structure is created to store information, such as session token 312, about a user session. The session token 312 that identifies the session data structure is stored in the web cookies. The session token 312 is generated for each new session data structure. The session token (or a session ID) 312 is an encrypted unique string that identifies the specific session instances. Session tokens serve as identifiers that maintain the state and continuity of the client device interaction with the web service. The session token 312 is generated and stored in web-browser cookies of the client device.

In an embodiment, the client device 204 stores session tokens or cookies 312 for legitimate sessions from service providers directly in the browser. Decoy session tokens generated and sent by the primary application 316 are injected into the browser via the extension.

In an embodiment, the primary application 316 is a proprietary service offered by a third party to monitor session token theft for multiple client devices registered with the primary application 316. The server side of the primary application provides services for monitoring and detecting session token theft. Users of client devices 304 can register with the primary application through an initial registration or enrollment process. During registration, the primary application 316 generates a unique identifier for each registered client device. The registration process may involve the user 302 providing credentials and logging into the browser extension for notification or account linking purposes.

Once a client device is registered with the primary application 316 and a unique identifier is generated for the device, the primary application 316 collects telemetry data from the client device. This telemetry data includes information such as domain names for stored session tokens or cookies, user-agent, public IP address, and the like.

In an embodiment of the present invention, the primary application 316 maintains a decoy site network 318 of web service providers that resembles with the web-page of the legitimate service provider 314. The session token of the web-pages of decoy site network 318, also referred herein as decoy session tokens are generated by the primary application 316. The decoy session tokens are generated and stored as “injected” session tokens or cookies for Decoy domains. The primary application 316 transmits decoy session tokens to the plurality of client devices 304 registered with the primary application 316. The client device 304 stores these decoy session token along with the legitimate session tokens 312 in the web-browser.

In an embodiment, the primary application 316 generates updated decoy session tokens and sends them at regular intervals to the client device 304. The client device updates these decoy session tokens in the browser at the same intervals. This allows the primary application 316 to map the decoy session tokens to the active session tokens at specific times. In the event of a session compromise, the primary application 316, which maintains a list of domain names for active session tokens of the client device, can identify and map the compromised session tokens.

In an embodiment, the primary application 316 periodically sends a beacon 320 to the client device 304. This time window mechanism allows the primary application to identify the time of an attack with sufficient granularity to determine which active sessions were compromised.

In an embodiment of the present invention, the primary application 316 comprising analytics module 208 and reporting module 210 for analyzing the timing of session token theft and mapping the decoy session token and legitimate session token to maintain a correlation between the decoy tokens and the user's actual session tokens. The correlation enables precise identification of which tokens were compromised and facilitates swift remediation action. The reporting module identifies the exact session tokens or cookies present in the user's browser at the time of session compromise.

In an embodiment of the present invention, the decoy site network 318 comprising a plurality of decoy domains or websites maintained by the primary application 316. These decoy sites are designed to resemble legitimate service provider websites, making them enticing to threat actors 308. The threat actors are unable to differentiate the decoy sites from legitimate ones and target the decoy site network.

The decoy site network 318 is specially configured to capture authentication attempts and session token use by third parties or threat actors. All session token attempts on a decoy site are relayed to the primary application 316, which identifies if the token is compromised. The primary application 316 regularly updates and manages the decoy session tokens.

In an embodiment, the decoy site network 318 captures submitted session tokens or cookies when an attacker attempts to use them and reports these attempts to the primary application 316. The primary application 316 then analyzes the reported session tokens and maps them with the active legitimate session tokens on the client device at that time.

A threat actor or an attacker 308 uses several mechanisms to steal session tokens stored in the client device, a proxy server, or in application or network logs. The attacker steals session tokens to access the user's data for as long as the stolen tokens remain active. The attacker may use viruses, worms 306, spyware, phishing, key loggers, or Trojans to subvert, cripple, or destroy a system, gather information, or install backdoors to take control of files and processes.

Once the attacker 308 has compromised a session of the client device 304 and gained access to the session token 312, the attacker hijacks the legitimate session with the service provider. The session token provides the attacker with unauthorized access to the user's personal accounts, leading to exposure of sensitive information and potential loss. The attacker may perform malicious actions, including data exfiltration, making unauthorized modifications, and using the compromised access as a pivot point to target additional services.

In an embodiment of the present invention, when a session of the client device 304 is compromised, the attacker steals the session tokens from the browser of the client device. For client devices 304 registered with the primary application 316, the stolen session tokens 312 include both legitimate session tokens and decoy session tokens.

The attacker attempts to reuse the stolen session tokens with both the legitimate service provider 314 and the decoy session network. The decoy site network 318, maintained by the primary application 316, captures these submitted session tokens or cookies and sends a report to the primary application 316. Additionally, the decoy site network captures telemetry data related to various web-based attacks, including password spraying, brute force attacks, credential stuffing, and other methods used by attackers. This data helps identify the actions of the attackers on the decoy site network.

In an embodiment, the primary application 316 detects the theft of session tokens by the attacker in real-time. Attackers typically attempt to use the stolen session tokens with legitimate service providers and the decoy site network as quickly as possible to prevent the session tokens from expiring.

The primary application 316 transmits alerts and notifications to the registered users and administrators of the client device 304 upon token misuse, allowing for faster mitigation and reducing the risk of data breaches. These notifications can be automated and programmatically sent, enabling rapid response. The exact identification of compromised session tokens provides clear visibility into the specific session tokens and cookies at risk, enabling targeted response.

The reporting or external alerting module 210 of the primary application 316 receives notifications or confirmations of detected compromises or thefts of session tokens or cookies. The customers of the external alerting module 210 may include individual users, enterprises 118, and cyber threat intelligence companies 116. The external alerting module 210 regularly notifies enterprise customers about the list of compromised client identifiers and compromised sessions. For cyber threat intelligence companies, the reporting or external alerting module 210 provides network telemetry of attackers and the dates of theft.

In conventional tracking, an attacker may sell the stolen session token information immediately on the dark web, underground markets, through access brokers, or in data dumps 110, or they may reuse it themselves. Corporations 118 hire third-party intelligence companies 116 to monitor these cyber threats. Compromises may also be detected by clients or service providers. When a threat actor or attacker decides to place the stolen information or access up for sale, these intelligence companies detect or procure it. The dwell time depends on how quickly the attacker decides to sell the information and how promptly it is identified by the service provider, client, or intelligence companies.

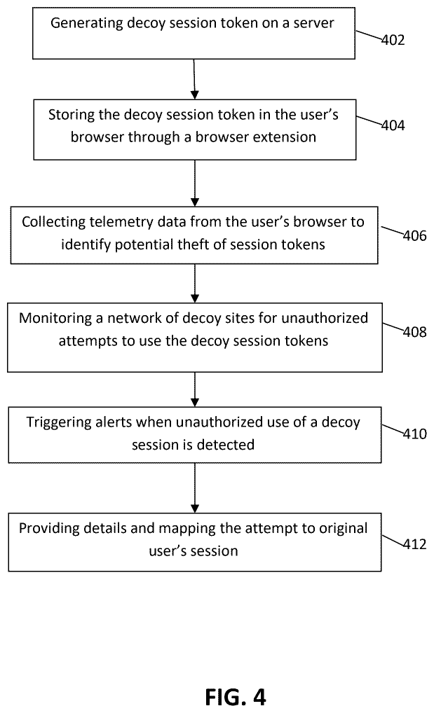

FIG. 4 illustrates a process for detecting the browser session token theft, in accordance with an embodiment of the present invention. The method may be performed by processing logic that may comprise hardware, software or combination thereof. The method may be performed by various modules and system components as described in FIG. 2 and FIG. 3.

Referring to FIG. 4, the method commences at operation 402 with the server of a primary application (a web-based application) generating a plurality of decoy session tokens for a Decoy site network. The generated decoy session tokens are transmitted by the primary application to a client device that is registered with the primary application for monitoring and detecting theft of session tokens from the client device.

At operation 404, the client device receives the plurality of decoy session tokens from the primary application and stores them in the web browser through a browser extension. This extension injects the decoy session tokens into the browser, where they are stored alongside the legitimate session tokens of the service providers actively running on the client device.

At operation 406, the primary application or web-based application receives telemetry data from the client device that includes domains for currently stored cookies, user-agent, and public IP address.

At operation 408, the primary application monitors the network of decoy sites for unauthorized attempts to use the decoy session tokens. When an attacker steals session token information from the client device, either through infostealer malware or an adversary-in-the-middle (AiTM) attack, the decoy session tokens are transmitted along with the legitimate session tokens. The attacker then attempts to use these tokens to open sessions with legitimate service providers and the decoy site network. When an unauthorized attempt is made to access the decoy site network, the primary application receives an alert.

At operation 410, when an authorized use of a decoy session is detected by the primary application, the primary application triggers an alert to the client device that a session is compromised.

At operation 412, the primary application maps the plurality of decoy session tokens with the original session tokens active at that time and provides details to the client device about the original session and session token which are compromised.

In an embodiment, the method further comprising the step of: storing metadata about each decoy session token, including creation time, associated real session token, and detected unauthorized attempt in a secure database.

In an embodiment, the injection of decoy session tokens is adaptive, adjusting the distribution and characteristics of decoy tokens based on observed attack patterns and threat intelligence.

The present invention stands out from traditional cybersecurity solutions, including honeypots, Endpoint Detection and Response (EDR) systems, Multi-Factor Authentication (MFA) systems, and Network Intrusion Detection Systems (NIDS), through its unique integration of decoy session tokens within the browser environment. Unlike traditional honeypots, which typically involve setting up decoy systems or networks to attract attackers and require significant resources to maintain and monitor, the present invention deploys a network of decoy sites specifically designed to entice attackers to use stolen decoy session tokens. This approach is more seamless and resource-efficient, providing real-time detection and response capabilities.

Traditional Honeypots vs. Present Invention: Traditional honeypots are primarily designed to study attacker behavior by attracting them to decoy systems or networks. They often rely on creating fake identities, accounts, or systems to monitor login attempts and identify vulnerabilities. These systems frequently use protocols like NTLM authentication, Kerberos, or other methods tied to specific fake user accounts. Additionally, traditional honeypots often set up fake virtual environments, such as SSH logins or fake listening services/ports, to entice network-based attacks. In contrast, the present invention does not depend on these traditional methods. Instead, it employs a new form of decoy session tokens that target infostealer malware and Adversary-in-the-Middle (AiTM) attacks. These decoy tokens are seamlessly integrated into the user's browsing environment and mimic legitimate session tokens, making them an effective lure for attackers. The invention's real-time detection and response capabilities enable immediate threat mitigation, significantly reducing the window of opportunity for attackers. Additionally, the decoy tokens are monitored through a network of decoy sites, designed to resemble legitimate services and entice attackers, providing detailed insights into unauthorized attempts. Unlike traditional honeypots, which monitor login attempts from specific fake users or setups to identify vulnerabilities, the present invention focuses on identifying unauthorized use of decoy session tokens and mapping these attempts back to valid session tokens on the user's browser at the time of the theft.

Endpoint Detection and Response (EDR) Systems vs. Present Invention: EDR systems focus on monitoring and analyzing endpoint activities to detect malicious behavior, often relying on agents installed on endpoints. These agents can be bypassed by sophisticated malware, and EDR systems do not stop all infostealer or session hijacking (AiTM) attacks. The present invention, however, operates within the web browser, reducing dependency on endpoint agents and increasing resilience against malware that targets traditional EDR systems. By using decoy tokens, the invention detects attempts to use stolen decoy tokens and maps these attempts back to legitimate session tokens active in the user's browser at the time of theft, thereby providing a higher level of security.

Multi-Factor Authentication (MFA) Systems vs. Present Invention: While MFA systems enhance security during the initial login process by requiring multiple forms of verification, they can be bypassed if session tokens are stolen after authentication. The present invention addresses this vulnerability by continuously monitoring session tokens throughout their lifecycle. The integration of decoy tokens adds an additional layer of security, trapping attackers attempting to reuse stolen tokens. This approach complements MFA systems by providing ongoing detection against session token theft attempts.

Network Intrusion Detection Systems (NIDS) vs. Present Invention: NIDS monitor network traffic to identify suspicious patterns and potential intrusions, focusing on network-level threats. They can generate false positives and require significant tuning to avoid alert fatigue. The present invention specifically targets application-layer attacks, such as session token theft, providing a more focused and accurate detection mechanism. By using decoy tokens that closely mimic legitimate tokens, the invention reduces false positives and ensures high accuracy in detecting unauthorized use. The system's ability to correlate telemetry data with decoy token usage provides a comprehensive understanding of potential compromises.

Unique Features and Benefits: The present invention offers several unique features that set it apart from existing cybersecurity solutions:
a. Real-Time Detection and Response: The system provides real-time alerts and responses related to unauthorized use of decoy tokens, enabling immediate threat mitigation.
b. Seamless Integration: Operating entirely within the browser environment, the system requires no additional software or agents on user devices, simplifying deployment and maintenance.
c. Detection of Unauthorized Use: By using decoy tokens, the system detects attempts to use stolen decoy tokens and maps these attempts back to legitimate session tokens active in the user's browser at the time of theft, enhancing overall security posture.
d. Comprehensive Telemetry Analysis: The system collects and analyzes telemetry data to map unauthorized attempts to specific user sessions, providing detailed insights into potential compromises.

By integrating these advanced features and leveraging decoy session tokens, the present invention offers a robust and innovative solution to browser session token theft, significantly enhancing security while minimizing resource overhead. The system's ability to detect unauthorized attempts to use decoy tokens, map these attempts back to active session tokens on the client device, and provide real-time alerts makes it a novel and effective tool in the fight against cyber threats. Additionally, unlike existing methods that rely on identifying stolen session tokens based on their impact or third-party monitoring of sales on the dark web, this invention provides a proactive and immediate method to detect and respond to token theft attempts.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or”means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

We claim:

1. A system for detecting browser session token theft, comprising:
a web-based application, deployed at a client device, configured to:
generate a plurality of decoy session tokens;
inject and store the plurality of decoy session tokens alongside legitimate session tokens in a browser extension in a client device, said client device transmitting telemetry data to the web-based application;
a network of decoy sites designed to monitor the usage of the plurality of decoy session tokens and detect unauthorized use of a decoy session token with the network of decoy sites, said network of decoy sites transmitting a signal to the web-based application upon detecting said unauthorized use; and
an analytics module of the web-based application to map the telemetry data, collected from the client device, to the corresponding decoy session token identified in said unauthorized use, thereby identifying a list of potentially compromised legitimate session tokens of the client device;
wherein the web-based application provides notifications to the client device and sends a list of compromised legitimate session tokens, upon detecting said unauthorized use.

2. The system of claim 1, wherein the telemetry data of the client device comprising at least one or more of a web domain name for cookies or session tokens stored in the browser, user agent, public IP-address.

3. The system of claim 1, wherein the decoy session tokens are generated by encrypting unique identifiers related to the client device and base64 encoding the encrypted unique identifiers to closely mimic the characteristics of legitimate session tokens, and each generated decoy session token is unique to its corresponding decoy domain.

4. The system of claim 3, further comprising:
a session correlation database that maintains mappings between the decoy session tokens and the legitimate session tokens to accurately identify the list of potentially compromised legitimate session tokens.

5. The system of claim 1, wherein the network of decoy sites is configurable to resemble various types of services, providing flexibility to deploy decoy sites that appear to host different legitimate services.

6. The system of claim 4, wherein the web-based application provides notifications to the client device using an alert mechanism which includes: real-time notifications sent to users and administrators, which can be automated and programmatically sent, detailing the unauthorized use, including IP address, time of use, and specific decoy token used.

7. A method for detecting browser session token theft, comprising:
generating decoy session tokens by deploying a web-based application at a client device;
injecting and storing the generated decoy session tokens in a browser through a browser extension at the client device;
collecting telemetry data from the browser to identify potential theft of session tokens;
monitoring a network of decoy sites for unauthorized attempts to use the decoy session tokens at the network of decoy sites; triggering alerts when unauthorized use of a decoy session token is detected on the decoy site network, wherein the alerts comprise detailed information of the unauthorized use further including a mapping of the deployed session token corresponding to the unauthorized use with the original and legitimate session tokens active at the client device;
wherein, the detection of the browser session token theft including detecting the deployed session token corresponding to the unauthorized use is real time and does not extend to the initial theft of legitimate session tokens, which are, instead, identified through further analysis and correlation with the telemetry data.

8. The method of claim 7, further comprising:
storing metadata about each decoy session token, including creation time, associated real session token, and any detected unauthorized attempts of use, in a secure database.

9. The method of claim 7, wherein the storage of decoy session tokens is adaptive, adjusting the distribution and characteristics of decoy tokens based on observed attack patterns and threat intelligence.

10. A system, comprising:
a server module that generates and manages decoy session tokens;
a web-based application at a client device that injects and stores the decoy session tokens in a browser extension in the client device and collects telemetry data from a user's browser at the client device;
a network of decoy websites that mimics legitimate services to detect unauthorized use of legitimate session tokens;
an analytics module that identifies and logs unauthorized attempts to use the generated decoy session tokens;
a notification system that issues alerts upon detecting unauthorized use of the decoy session tokens, enabling rapid response.

11. The system of claim 10, further comprising:
a browser extension that facilitates the storage and management of the decoy session tokens within the user's browser environment.

12. The system of claim 10, wherein the analytics module utilizes advanced algorithms to analyze patterns of unauthorized attempts of use on the network of decoy sites, improving the accuracy and speed of threat detection.

13. The system of claim 10, wherein the notification system integrates with existing security information systems to provide comprehensive threat analysis and response capabilities.

14. The system of claim 10, further comprising:
a method for integrating the decoy token sessions detection capabilities with third-party security tools and platforms, facilitating alerts or notifications and enhancing overall security posture.
